(19) United States
(12) Patent Application Publication
(10) Pub. No.: US 2013/0110815 A1
(43) Pub. Date: May 2, 2013

(54) GENERATING AND PRESENTING DEEP LINKS

(71) Applicants: Vladimir Tankovich, Bellevue, WA (US); Victor Poznanski, Sammamish, WA (US); Dmitriy Meyerzon, Bellevue, WA (US)

(72) Inventors: Vladimir Tankovich, Bellevue, WA (US); Victor Poznanski, Sammamish, WA (US); Dmitriy Meyerzon, Bellevue, WA (US)

(73) Assignee: Microsoft Corporation, Redmond, WA (US)

(21) Appl. No.: 13/283,632

(22) Filed: Oct. 28, 2011

(51) Int. Cl. G06F 17/30

(52) U.S. Cl. 707/711; 707/741; 707/722; 707/723; 707/E17.108; 707/E17.014

(57) ABSTRACT

Concepts and technologies are described herein for generating and presenting deep links. In accordance with the concepts and technologies disclosed herein a search engine is configured to generate deep links associated with a site. A site is identified by the search engine and the site is analyzed by the search engine with data relating to searches of and/or usage of the site. The search engine identifies links or other resources contained in, associated with, or referenced by the site, generates deep links corresponding to the resources, and associates the deep links with the site. If a site having indexed deep links is identified in search results, the search engine identifies one or more deep links associated with the site and presents the deep links with the search results to provide a searcher with relevant resources that may not satisfy the search query submitted by the searcher.

### BACKGROUND

Because of the constantly growing amount of information on the Internet, searching has become an important aspect of finding resources and information. Search engines search the Internet and other networks to identify sites and other resources available on the networks. These sites and other resources are analyzed, categorized, and indexed by the search engines for use in executing search queries.

Sites or resources identified in search results can include any number of links, embedded files, and/or other information that may or may not be relevant to a searcher. In particular, users often underspecify search queries and as a result, search results that satisfy the query may not include resources that are directly relevant to a searcher. As such, searchers may be required to access sites or resources identified in a search result list and subsequently navigate through the site or resource to find information that is actually relevant to the searcher. Generally, accessing information included in, or referenced by, a site or resource entails accessing the site or resource and reviewing the site or resource to find the relevant information.

It is with respect to these and other considerations that the disclosure made herein is presented.

### SUMMARY

Concepts and technologies are described herein for generating and presenting deep links. In accordance with the concepts and technologies disclosed herein, sites are indexed during an indexing operation and links or resources within or associated with the site are identified. A “site,” as used herein and in the claims, can include but is not limited to a collaboration site, a web site, a domain, a document, a directory, a library, a folder, and/or any other resource or collection of resources that may be used or indexed. Search information from searches and/or generic usage information (“search and/or usage information) associated with the links or resources is analyzed to determine links or resources that are relevant to searches that return the site as a search result. The search and/or usage information can include click-through rates (“CTR”), read-through rates (“RTR”), and/or other usage metrics associated with the link or resource. The search and/or usage information also can indicate a number or percentage that indicates how often the link or resource is returned in a search that returns the site. Administrators or other entities can curate the search and/or usage information, which also can be normalized relative to total site traffic, if desired.

According to one aspect, a search engine is configured to generate deep links. A site is identified by the search engine, for example during an index operation. The search engine analyzes the site and data relating to the site. During this analysis, links and/or other resources contained within or referenced by the site are identified and usage and search statistics associated with these links and/or resources are analyzed. Deep links are generated by the search engine and associated with the site. The deep links can include links or resources included in or referenced within the site that are determined to be relevant to a searcher obtaining the site as a search result. One or more of the generated deep links also can be used to identify the site itself.

In some embodiments, a score is generated for each deep link. The score can be based upon various search and/or usage statistics to identify a relative or absolute weight associated with the deep link. In some instances, the score is based upon a relative weight associated with the deep link, wherein the weight is measured relative to a total usage and/or a curated value. The score can be used to show or hide the deep link, to rank two or more deep links, to determine a number of deep links to show with search results, and/or for other purposes. The search engine stores the deep links and/or data identifying an association between a deep link and a site in the search index.

According to another aspect, a search engine is configured to present deep links as part of search results. The search engine receives a query and obtains search results satisfying the query. The search results are analyzed to determine if any of the search results are associated with one or more deep links. In some embodiments, the search results are analyzed to determine if a site having deep links indexed by the search engine is referenced by one or more of the search results.

If a site having indexed deep links is identified in the search results, the search engine identifies one or more deep links associated with the site. The search engine can apply security policies and/or scores to the deep links to determine what results to hide or show and/or how to rank or order the search results. The search engine also can present the search results in a user interface. The results presented by the search engine can include the identified, ranked, and/or security-policy-approved deep links.

It should be appreciated that the above-described subject matter may be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a system diagram illustrating an illustrative operating environment for the various embodiments disclosed herein.

FIG. 2 is a flow diagram showing aspects of a method for generating deep links, according to an illustrative embodiment.

FIG. 3 is a flow diagram showing aspects of a method for presenting deep links, according to an illustrative embodiment.

FIGS. 4A-4G are user interface diagrams showing aspects of user interfaces for presenting deep links, according to various illustrative embodiments.

FIG. 5 is a computer architecture diagram showing an illustrative computer hardware and software architecture for a computing system capable of implementing aspects of the embodiments presented herein.

### DETAILED DESCRIPTION

The following detailed description is directed to concepts and technologies for generating and presenting deep links. According to the concepts and technologies described herein, a search engine is configured to generate deep links associated with a site. A site is identified by the search engine and the site is analyzed by the search engine with data relating to searches of and/or usage of the site. The search engine identifies links or other resources contained in, associated with, or referenced by the site. The search engine generates deep links and associates the deep links with the site. The deep links can include links or resources included in or referenced within the site that are determined to be relevant to a searcher obtaining the site as a search result.

The search engine also can generate scores for each deep link. The scores can be based upon various search and/or usage statistics and can correspond to a determined relative or absolute weight associated with the deep link. The score can be used to show or hide the deep link, to rank two or more deep links, to determine a number of deep links to show with search results, and/or for other purposes. The search engine can store the deep links and/or data identifying an association between a deep link and a site in the search index.

The search engine also can be configured to present deep links to users or other entities in response to search results. The search engine can receive a query, obtains search results satisfying the query, and analyze the search results to determine if any of the search results are associated with deep links. If a site having indexed deep links is identified in the search results, the search engine identifies one or more deep links associated with the site. The search engine can apply security policies and/or scores to the deep links to determine what results to hide or show and/or how to rank or order the search results. The search engine also can present the search results in a user interface. The results presented by the search engine can include the identified, ranked, and/or security-policy-approved deep links.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and in which are shown by way of illustration specific embodiments or examples. Referring now to the drawings, in which like numerals represent like elements throughout the several figures, aspects of a computing system, computer-readable storage medium, and computer-implemented methodology for generating and presenting deep links will be presented.

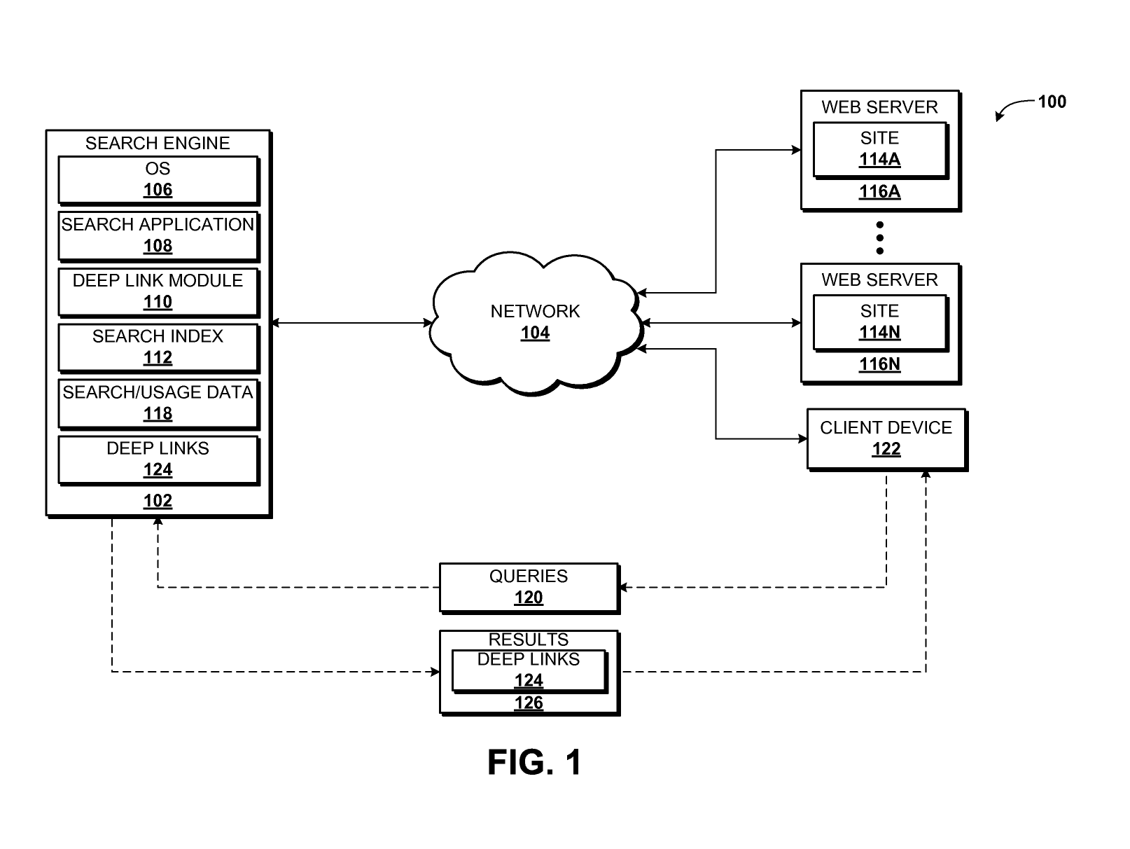

Referring now to FIG. 1, aspects of one operating environment 100 for the various embodiments presented herein will be described. The operating environment 100 shown in FIG. 1 includes a search engine 102 operating on or in communication with a network 104. The search engine 102 is configured to execute an operating system 106 and one or more application programs such as, for example, a search application 108, a deep link module 110, and/or other application programs.

The operating system 106 is a computer program for controlling the operation of the search engine 102. The application programs are executable programs configured to execute on top of the operating system 106 to provide the functionality described herein for generating and presenting deep links. Although the search application 108 and the deep link module 110 are illustrated as components of the search engine 102, it should be understood that each of these components, or combinations thereof, may be embodied as or in stand-alone devices or components thereof operating on or in communication with the network 104 and/or the search engine 102. Thus, the illustrated embodiment is illustrative, and should not be construed as being limiting in any way.

The search application 108 is configured to create, maintain, modify, and/or perform queries or other operations against a search index 112. In general, the search application 108 is configured to identify, analyze, and/or catalogue data describing one or more sites 114A-N (hereinafter collectively or generically referred to as “sites 114”) hosted by or associated with one or more web servers 116A-N (hereinafter collectively or generically referred to as “web servers 116”) operating on or in communication with the network 104. The sites 114 can correspond to any type of resources hosted by or associated with the web servers 116 including, but not limited to, computer-executable and/or computer-readable code corresponding to computer files, computer applications, software, modules, multimedia files, text files, web pages, other types of files, combinations thereof, or the like. The sites 114 also can include, but are not limited to, one or more and/or a combination of one or more web sites, domains, documents, directories, files, libraries, folders, and/or any other resources or collections of resources that may be used or indexed. Thus, while the sites 114 are described herein as being associated with web or network sites, it should be understood that this embodiment is illustrative, and should not be construed as being limiting in any way.

The search application 108 is configured to identify the sites 114 during web searches and/or during indexing or cataloguing of web content and to generate and store data identifying the sites 114 in the search index 112, as is generally understood. The search application 108 can obtain copies of the sites 114, or access remote copies of the site 114 and perform analysis of the contents of the sites 114. During this analysis, the search application 108 can identify links, resources, files, images, and/or other information associated with the sites 114 and store data identifying this information in the search index 112. The information stored in the search index 112 can be used during search queries and/or at other times for analysis, as is explained in more detail below.

In some embodiments, the search application 108 also is configured to generate and store search and usage data (“search/usage data”) 118. The search/usage data 118 can include data describing searches for which results included a site 114, for example. The search/usage data 118 also can indicate click-through information that indicates a percentage or raw number of times searchers clicked on a search result corresponding to the site 114. The search/usage data 118 also can include detailed information associated with the site 114 including, for example, links within the site 114 that are identified during searches, click-through rates (“CTR”) tracked and/or determined by the search engine 102 by analyzing click-through logs, read-through rates (“RTR”) determined by systems or devices hosting or associated with the site 114, which can be shared with the search engine 102, and/or other usage information associated with these links within the site 114, and/or various information associated with the sites 114 and/or associated links, files, or other resources. In some embodiments, users or other entities are able to curate and/or assign relative importance and/or weights to one or more data included in the search/usage data 118. As such, users or other entities can create or modify the search/usage data 118 to reflect or include data indicating a relative or subjective importance. Additional uses of the search/usage data 118 are described in more detail below.

According to various embodiments, the search engine 102 receives one or more queries 120 from a client device 122. The queries 120 can correspond, for example, to search strings. As is generally understood, the search engine 102 can execute the queries 120 against the search index 112 and return one or more search results in response to the queries 120. According to various embodiments, the functionality of the client device 122 is provided by a personal computer (“PC”) such as a desktop, tablet, or laptop computer system. The functionality of the client device 122 also may be provided by other types of computing systems including, but not limited to, server computers, handheld computers, netbook computers, embedded computer systems, personal digital assistants, mobile telephones, smart phones, or other computing devices. The client device 122 is configured to execute one or more applications to allow a user of the client device 122 to submit the queries 120 to the search engine 102, to view search results generated by the search engine 102, to access resources associated with search results, and/or various other functionality. The client device 122 is described herein as corresponding to a consumer computing device executing a web browser. In view of the many alternatives discussed above, it should be understood that this embodiment is illustrative, and should not be construed as being limiting in any way.

The deep link module 110 is configured to analyze data stored in the search index 112, the contents of the site 114, the search/usage data 118, and the queries 120 to generate deep links 124 associated with the site 114. As used herein, the “deep links” are links, files, information, and/or other resources identified in the site 114 and/or identified by the search engine 102 as being associated with the site 114 that the search engine 102 determines to be relevant to a user receiving identification of the site 114 in search results. According to implementations, the deep links 124 include, but are not limited to, links appearing on web pages identified in search results, information or references to information included in a site 114, information or resources relating to the site 114, images or files embedded or referenced in the site 114, and/or other information, resources, links, applications, documents, or other files.

The deep link module 110 is configure to review the contents of the site 114 and the search/usage data 118 associated with the site 114, as well as other data describing use and/or access of the site 114 and/or return of the site 114 in search results. Based upon the site 114 and/or the search/usage data 118, the deep link module 110 generates deep links 124 that can be presented in search results with information identifying the site 114, if desired. In some embodiments, the deep link module 110 also is configured to generate a score associated with the deep links 124. The scores can be generated for each association of a deep link 124 and a site 114. The score can indicate a relative weight that is assigned to a particular deep link 124 in the context of a query 120 that generates a search result corresponding to the site 114.

According to some embodiments, the scores are based upon one or more formulae that take into account CTR, RTR, average click rates or numbers, and/or other metrics associated with the site 114 and/or the deep links 124. In other embodiments, the scores are also based upon a number of clicks required to access the resource identified by the deep link 124 from the site 114. In one contemplated embodiment, the score is calculated as

$$\frac{A \sqrt{clicks} + B \sqrt{usage}}{1 + distance} .$$

According to various embodiments, “clicks” are a number of clicks on the link identified by the deep link 124, wherein the number of clicks is calculated as the number of clicks on the link from any search results pages across any number of queries for which the link was returned and then clicked. According to various embodiments, “usage” is a number or rate of usage of the link identified by the deep link 124. The “usage” can correspond to a total number of times the link identified by the deep link 124 was clicked on the site, regardless of whether a searcher found the link in a search results page or whether the searcher navigated directly to the link. “Distance” corresponds, in various embodiments, to a number of clicks to access the resource, measured from the site 114. In the above example, A and B can include relative weight values that are assigned by user or software settings or input. It should be understood that this embodiment is illustrative, and should not be construed as being limiting in any way.

The scores can be used to determine how many deep links 124 to associate with each site 114. The number of deep links 124 to display with search results can be determined based upon user or software settings. In some embodiments, a first number of search results are displayed with a first number of deep links 124, a second number of search results are displayed with a second number of deep links 124, and a third number of search results are displayed with a second number of deep links 124. For example, in one embodiment, the first two search results of a search result list are shown with eight deep links 124, the next three search results of the search result list are shown with six deep links 124, and the next four search results of the search result list are shown with four deep links.

The numbers of deep links 124 can be varied, if desired, and also can be shown for a percentage of search results instead of, or in addition to, a raw number of search results. As such, the above embodiment should be understood as being illustrative and should not be construed as being limited in any way. In some embodiments, the deep links 124 are determined, scored, and/or assigned to sites 114 offline. For example, some embodiments include a timer job that causes the deep link module 110 to generate the deep links 124. The timer job can be set to five minutes, ten minutes, or other time periods. The deep links 124 can be generated at any time and assigned to search results at query time. According to various implementations, the deep links 124 are static and are not query-dependent. It should be understood that this embodiment is illustrative, and should not be construed as being limiting in any way.

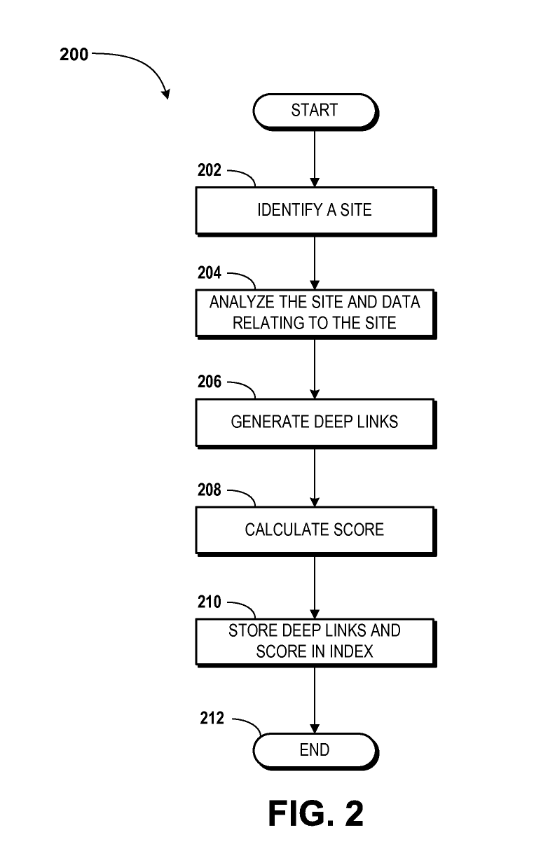

The search engine 102 is configured to generate results 126 via execution of one or more of the search application 108 and/or the deep link module 110. The results 126 can include search results identified as satisfying a query 120 and deep links 124 associated with sites 114 identified in the search results. The results 126 can be provided to the client device 122 or other device that generated the query 120. In some embodiments, the results 126 are provided as a results page or other user interface generated by the search application or other component of the search engine 102. As is generally understood, search results pages can be configured as dynamic web pages that are populated based upon search results and/or other information. Additional aspects of generating and presenting deep links 124 are described in more detail below with reference to FIGS. 2-4G.

In FIG. 1, the search index 112 is illustrated as being stored at, or in association with, the search engine 102. In some embodiments, the functionality of the search index 112 is provided by one or more data storage devices such as, for example, one or more databases, server computers, mass storage devices, memory devices, combinations thereof, and the like. It therefore should be understood that the search index 112 and/or the deep links 124 can be stored at a location that is remote from the search engine 102, if desired. Thus, the illustrated embodiment is illustrative, and should not be construed as being limited in any way.

FIG. 1 illustrates one search engine 102, one network 104, two web servers 116, and one client device 122. It should be understood, however, that some implementations of the operating environment 100 include multiple search engines 102, multiple networks 104, one or more than two web servers 116, and/or multiple client devices 122. Thus, the illustrated embodiments should be understood as being illustrative, and should not be construed as being limiting in any way.

Turning now to FIG. 2, aspects of a method 200 for generating deep links 124 will be described in detail. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For purposes of illustrating and describing the concepts of the present disclosure, the methods disclosed herein are described as being performed by the search engine 102 via execution of the search application 108 and/or the deep link module 110. It should be understood that these embodiments are illustrative, and should not be viewed as being limiting in any way. In particular, devices other than the search engine 102 can provide the functionality described herein by execution of any applications or modules including, but not limited to, the search application 108 and/or the deep link module 110.

The method 200 begins at operation 202, wherein the search engine 102 identifies a site 114. According to various embodiments, the site 114 is identified during an indexing operation performed by the search engine 102. As explained above, the indexing operation can be performed at regular intervals, on expiration of a timer job, or according to a schedule. The indexing operation also can be performed on-demand, in response to a number of searches, and/or at other times. In some embodiments, the indexing operation is performed in response to identification of the site during execution of a search query. As explained above with reference to FIG. 1, the site 114 can correspond to any type of resource including, but not limited to, applications, files, links, web sites, pages, documents, and the like.

In some embodiments, the site 114 can be identified by a shortest URL associated with a particular domain. In some embodiments, the concepts and technologies disclosed herein are used in conjunction with the SHAREPOINT family of collaboration products from Microsoft Corporation in Redmond, Wash. As such, the site 114 also can be identified by metadata associated with a site object created by a user in SHAREPOINT. The site 114 also can correspond to a top level navigation object that is associated with a collection of web pages, documents, applications, and/or other resources. Because the site 114 can be associated with any type of resources and/or hierarchy within resources, it should be understood that these embodiments are illustrative, and should not be construed as being limiting in any way.

From operation 202, the method 200 proceeds to operation 204, wherein the search engine 102 analyzes the site 114 and/or data describing searches and/or usage of the site 114. According to some embodiments, the search engine 102 obtains the search/usage data 118 described above in FIG. 1, though this is not necessarily the case. The data obtained in operation 204 can indicate various aspects of the site 114 including, but not limited to, a number of clicks or click-through rates (“CTR”) associated with the site 114 when included in a search result page or other result set, a usage rate or read-through-rate (“RTR”) associated with the site 114, and the like.

The analysis of operation 204 also can include analysis of the site 114 and/or various data describing links, resources, and/or other information included in or associated with the site 114. In particular, the search engine 102 can be configured to analyze the site 114 to identify contents of the site 114, files or other resources associated with the site 114, parent-child relationships associated with the site 114, and the like. As used herein, a “parent-child relationship” includes, but is not limited to, domains or web sites to which the site 114 belongs, is associated with, is located within, or the like, as well as other sites or links associated or located within the site 114. These and other data relating to the site 114 and/or relationships associated with the site 114 can be stored as or with the search/usage data 118.

From operation 204, the method 200 proceeds to operation 206, wherein the search engine 102 generates one or more deep links 124 associated with the site 114. The deep links 124 can include links or other references to information or resources included in, associated with, referenced by, or otherwise related to the sites 114. As such, it can be appreciated that the deep links 124 generated based upon the site 114 and/or the search/usage data 118 can indicate trending or important topics or links associated with the site 114.

For example, if a site 114 corresponds to a news page, one or more links on the news page may correspond to a developing, trending, new, or otherwise important news story. The search engine 102 can generate a deep link 124 for a link to the news story appearing on the site 114 based upon an assumption that a searcher receiving the site 114 in a search result list has an interest in the important news story. In another example, if the site 114 corresponds to a technology website, links within the site 114 that have been searched or accessed recently may be identified as being relevant to the average searcher, and a deep link 124 corresponding to these links or other resources. In general, the deep links 124 correspond to links or resources within the site 114 that are identified as being of interest to a generic searcher receiving the site 114 in a search result page or other search result set. As such, the above examples are illustrative, and should not be construed as being limiting in any way.

Each deep link 124 generated in operation 206 can be associated with the site 114, and data indicating this association can be stored in a suitable data storage device or location. In some embodiments, data identifying the association is stored in the search index 112. In some embodiments, the association is stored in the search index 112 as a property for data identifying the indexed site 114. As such, if the site 114 is identified as satisfying a search, the deep links 124 can be identified as being relevant to the query 120 and returned with or in the results 126. Furthermore, because the deep links 124 can be identified as properties for the sites 114, a number of deep links 124 can be associated with a particular site 114. In another contemplated embodiment, data identifying sites 114 is stored as properties in data identifying the deep links 124. Thus, the deep links 124 can be identified by searching properties associated with the deep links 124. Because other methods of generating the deep links 124 and/or associating the deep links 124 with the sites 114 are contemplated, it should be understood that these embodiments are illustrative, and should not be construed as being limiting in any way.

In some embodiments, the deep links 124 are generated only for links or resources that “belong” to the site 114 identified in operation 202. As used herein, a link or resource “belongs” to a site 114 if the links or resource is dependent upon the site 114. For example, if the site 114 includes a document library, a link or resource within the document library “belongs” to the document library. In some embodiments, only links or resources having non-zero clicks, read-throughs, or other usage statistics are considered as being eligible as deep links 124. It should be understood that this embodiment is illustrative, and should not be construed as being limiting in any way.

From operation 206, the method 200 proceeds to operation 208, wherein the search engine 102 calculates a score associated each generated deep link 124 and/or an association between a deep link 124 and a site 114. The score can identify the perceived relevance or importance of each deep link 124 relative to the site 114. As such, the score can indicate a perceived importance attached to displaying a particular deep link 124 in results 126 that include information identifying the site 114.

The score can be calculated based upon any number of considerations including, but not limited to, a number of times a link or resource identified as the deep link 124 appears in the site 114, a click-through rate, read-through rate, or other usage-based metric associated with the resource identified by the deep link 124, and/or other information. These and other data can be obtained and stored as the score as an absolute value, if desired. In other embodiments, these and other data are obtained for each deep link 124 associated with a particular site 114, and relative weights or scores are generated based upon the scores for the deep links 124.

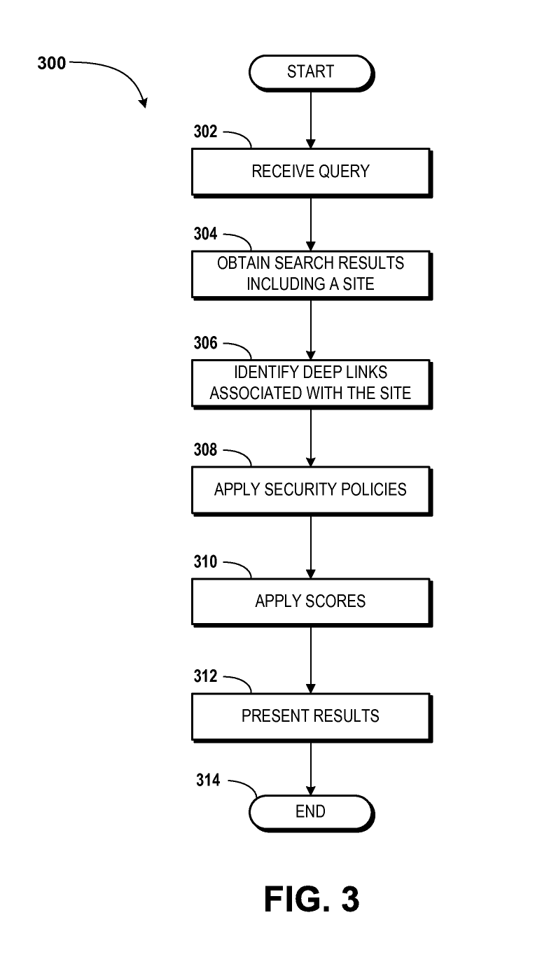

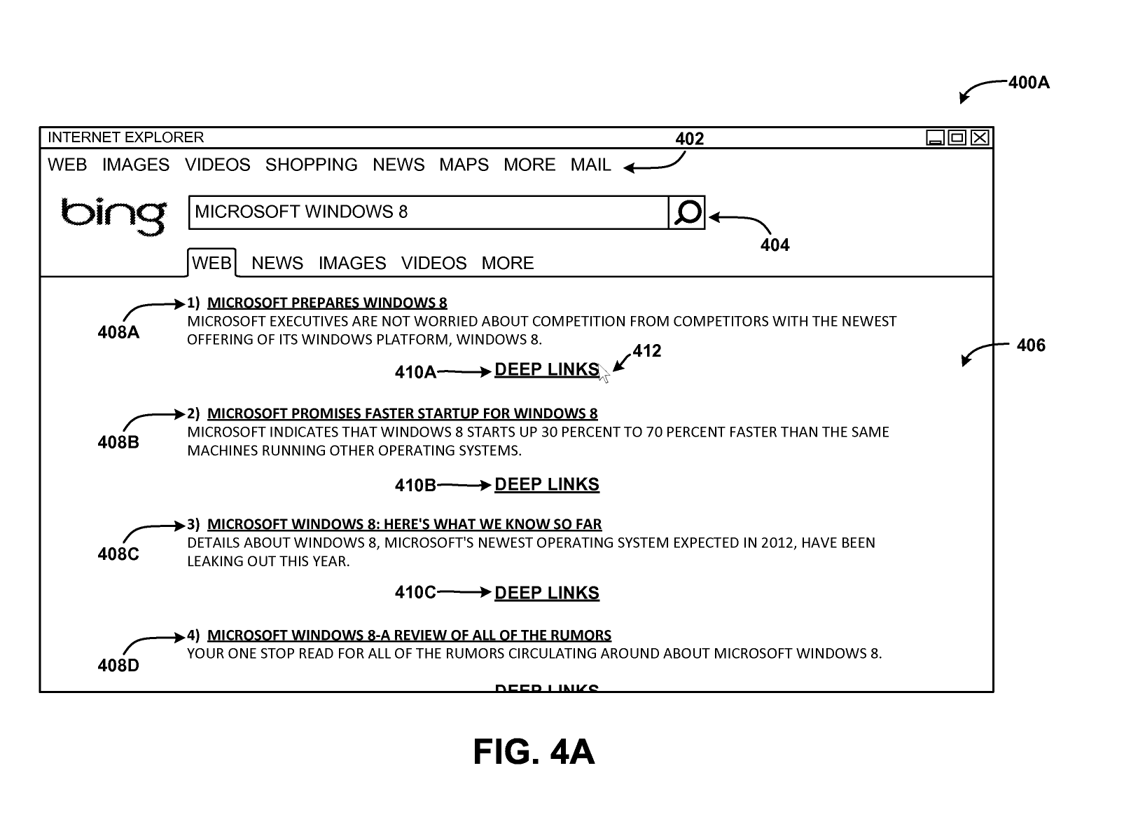

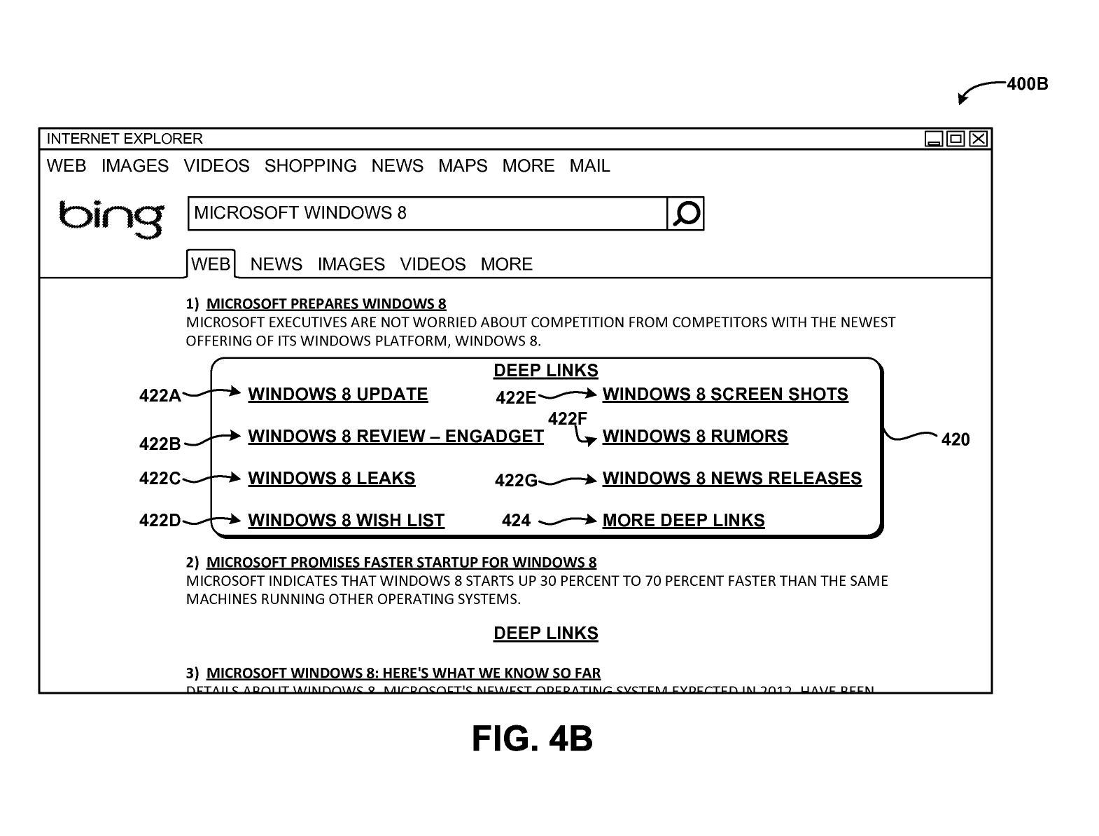

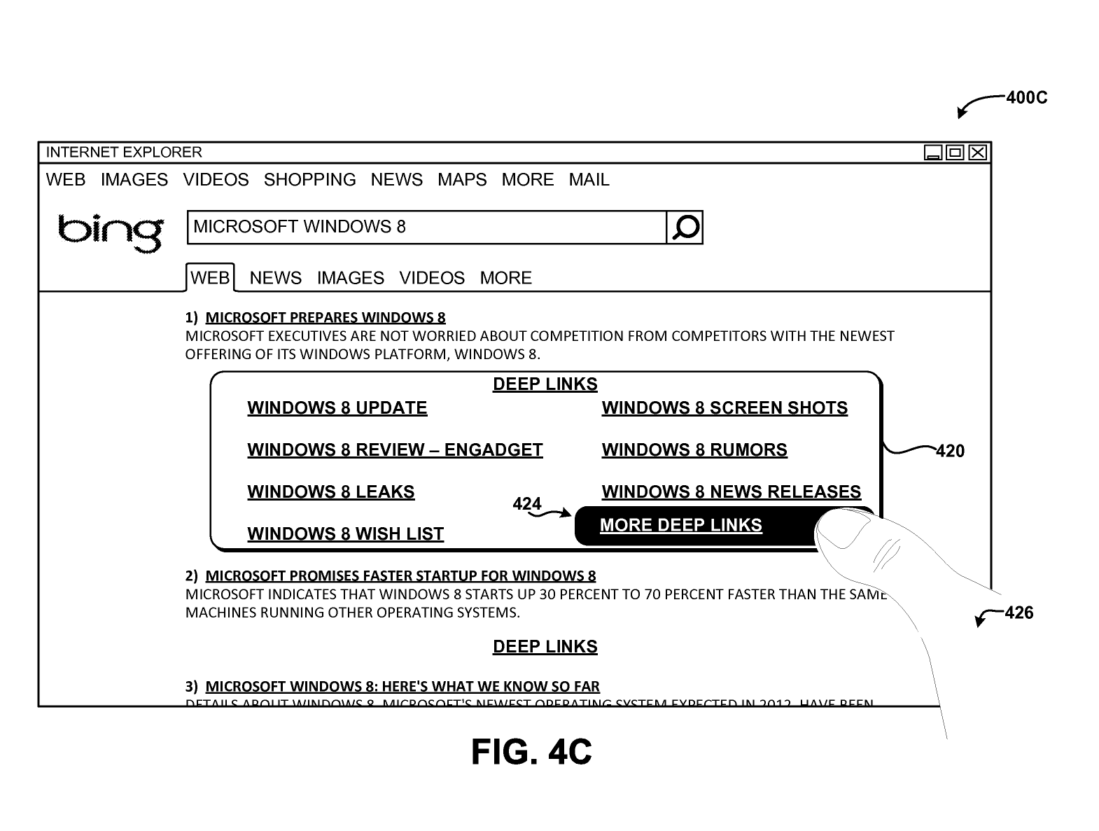

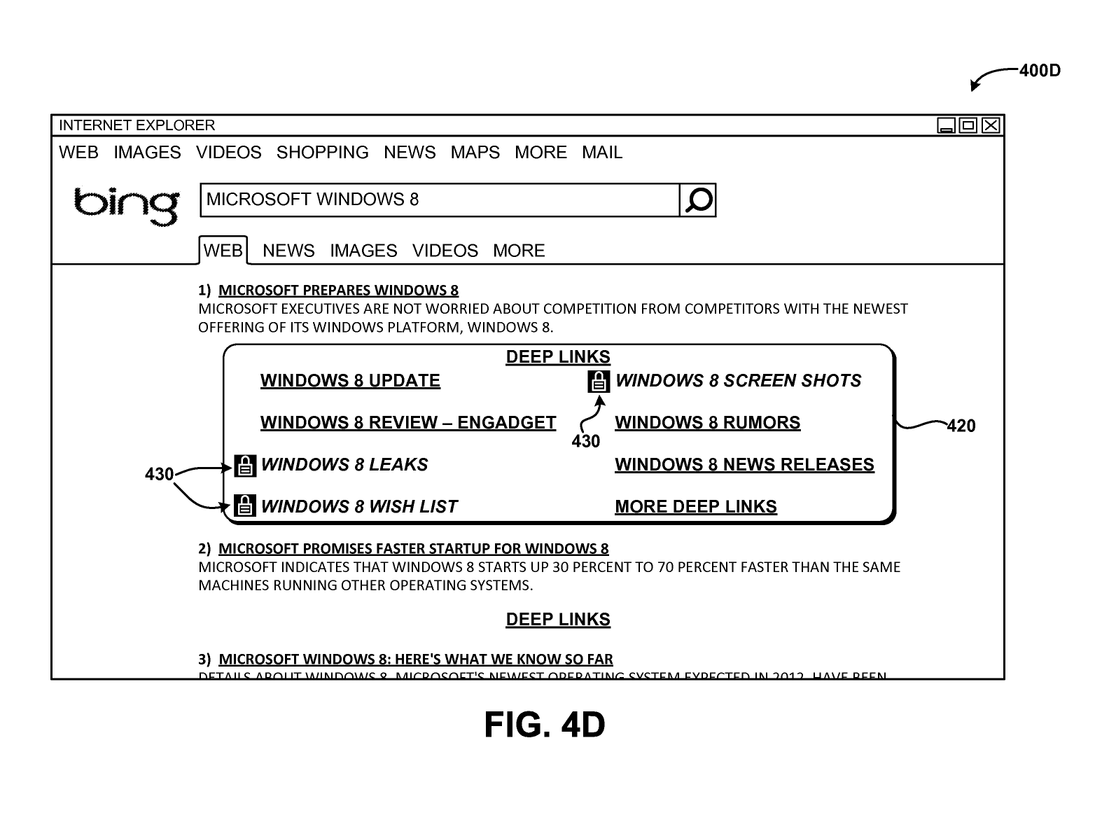

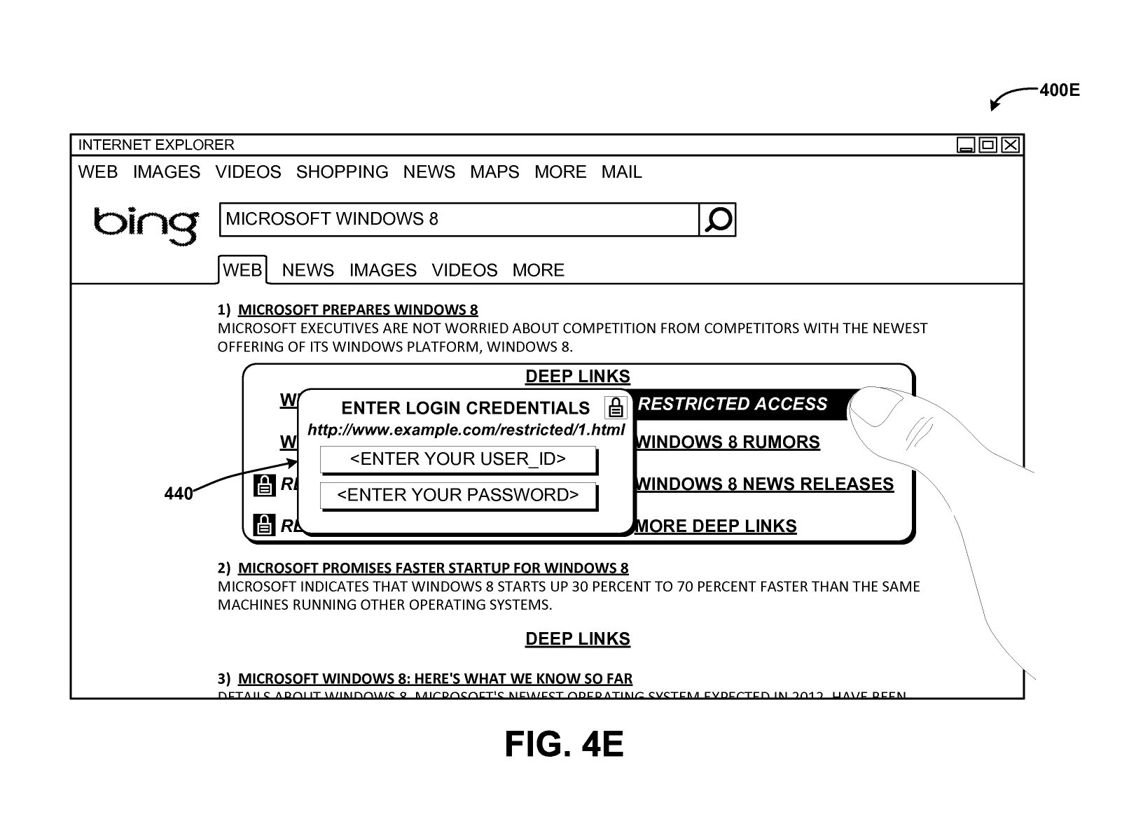

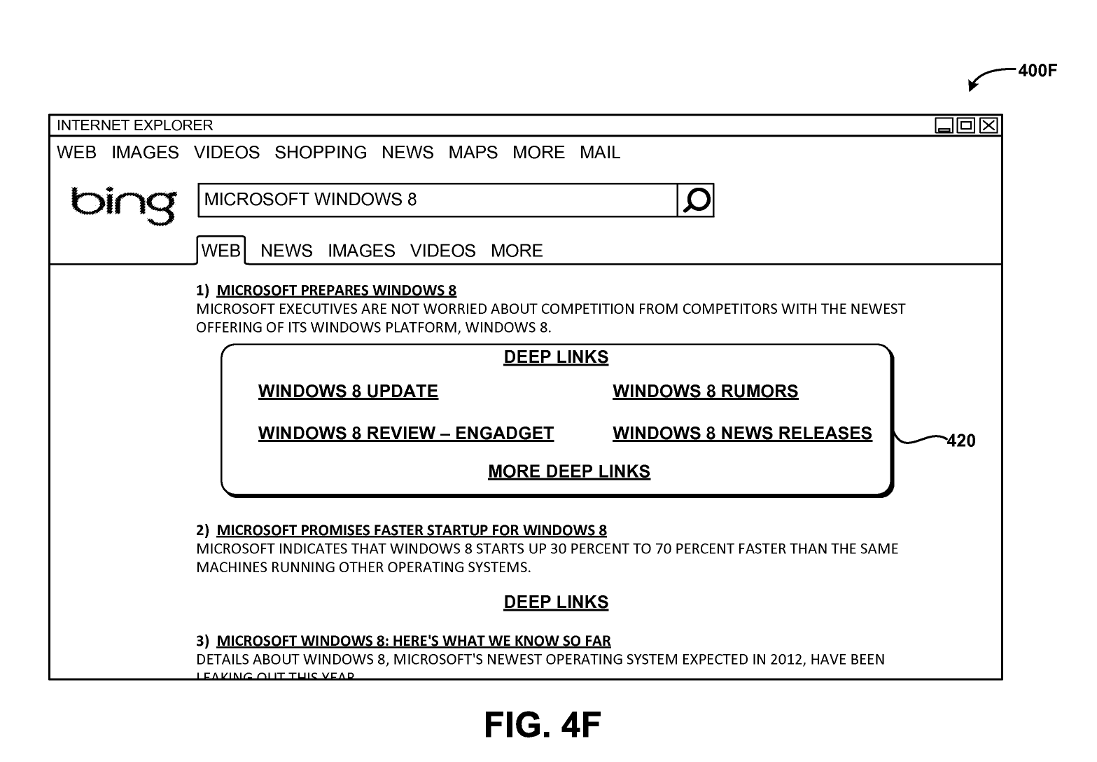

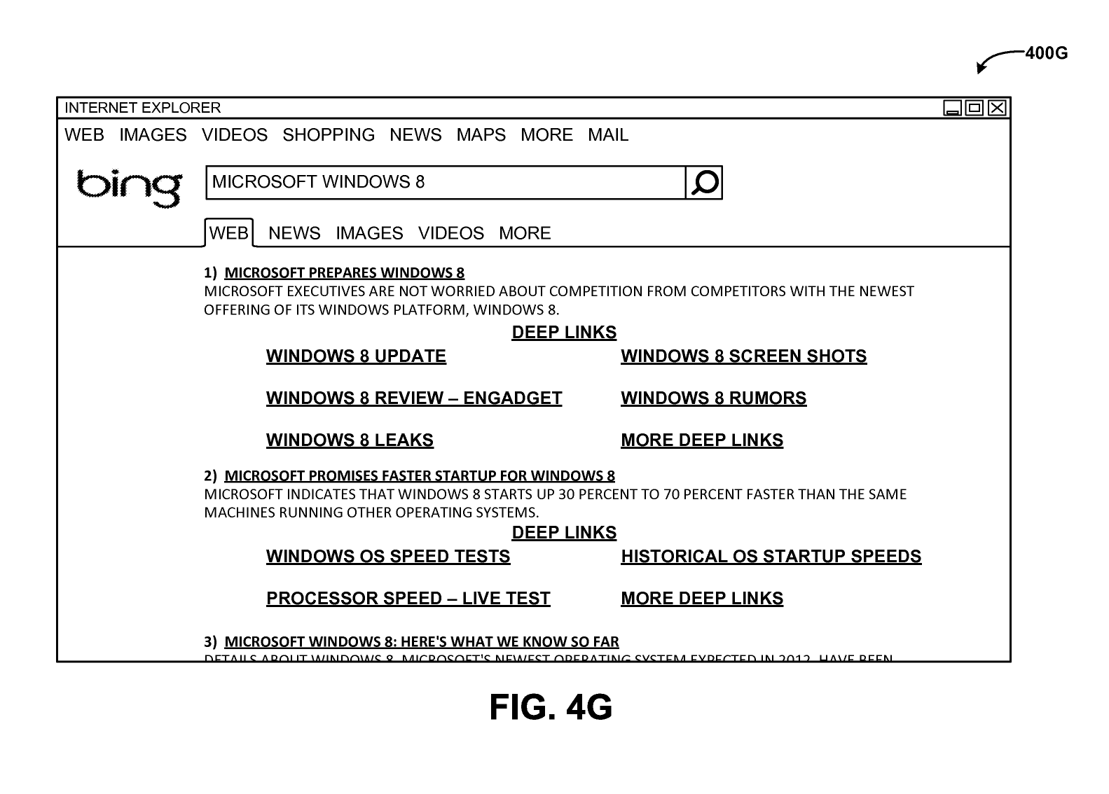

For example if four deep links 124 are generated for a particular site, an absolute value for the score can be generated for each deep link 124. In other embodiments, various values for the deep links 124 are evaluated and compared, and the score can be set as a simple order of preference based upon this relevance comparison. As such, the score can be a number that indicates an order ranking for the deep links 124 or an absolute score value. Other types of scores can be generated and/or used during presentation of the deep links 124, as will be described in more detail below with reference to FIGS. 3-4G.

From operation 208, the method 200 proceeds to operation 210, wherein the search engine 102 stores the deep links 124 and/or the scores in the search index 112. The deep links 124 stored in operation 210 can include the deep links 124 generated in operation 206, which can be stored in the search index 112 and/or can be stored as properties for data identifying the site 114 in the search index 112. In some embodiments, the data stored in operation 210 includes data identifying an association between the deep links 124 and the site 114. The data stored in operation 210 also can include the score calculated in operation 208 for the deep link 124 and/or the deep link 124 to site 114 association. The score also can be stored as a property for the deep links 124, if desired. The deep links 124 and/or the score can be stored in the search index 112, as properties for other data stored in the search index 112, and/or can be stored at other data storage locations.

As explained above, the functionality described herein with reference to FIG. 2 can be executed at any time. In some embodiments, the method 200 is executed in response to expiration of a timer job, though this is not necessarily the case. In other embodiments, the method 200 is executed when the search application 108 identifies a new site 114 to index in the search index 112. Because the method 200 can be executed at any time, the above examples should be understood as being illustrative and should not be construed as being limited in any way. Similarly, it should be understood that the functionality described herein can be repeated until an indexing operation is completed.

From operation 210, the method 200 proceeds to operation 212. The method 200 ends at operation 212.

Turning now to FIG. 3, a method 300 for presenting deep links 124 will be described, according to an illustrative embodiment. The method 300 begins at operation 302, wherein the search engine 102 receives a query 120. As explained above, the query 120 can be received from any entity or device. In the illustrated embodiment, the query 120 is received from a client device 122 and can be submitted, for example, via a web browser or other application program. Because the query 120 can be received from any number of devices or entities, and/or via any number of application programs, it should be understood that this embodiment is illustrative, and should not be construed as being limiting in any way.

From operation 302, the method 300 proceeds to operation 304, wherein the search engine 102 obtains search results that satisfy the query 120. The query 120 can be executed against the search index 112, as is generally understood. For purposes of describing the concepts and technologies disclosed herein, it is assumed that the search results obtained in operation 304 include a site 114 such as the site 114 analyzed in the method 200 described with reference to FIG. 2 above. It should be understood that this embodiment is illustrative, and should not be construed as being limiting in any way.

From operation 304, the method 300 proceeds to operation 306, wherein the search engine 102 searches the search index to identify one or more deep links 124 associated with the site determined to exist in the search results obtained in operation 304. As explained above, the deep links 124 can be identified by properties stored with data identifying the site 114 in the search index 112, if desired. Thus, operation 306 can include searching properties of data identifying the site 114 to determine if any deep links 124 are referenced in the properties.

As explained above, deep links 124 can be associated with sites 114 in other ways including, but not limited to, storing data associations that indicate a relationship between deep links 124 and sites 114. Thus, operation 306 can include searching association data to determine if any deep links 124 are associated with a particular site 114. The deep links 124 also can store properties that indicate related sites 114, and therefore operation 306 can include searching properties of the deep links 124 instead of, or in addition to, searching properties of data identifying the sites 114.

From operation 306, the method 300 proceeds to operation 308, wherein the search engine 102 applies security policies to the deep links 124 identified in operation 306. In some embodiments, a site 114 may be identified during a search and may not be subject to restricted access or security policies. Deep links 124 associated with the site 114, however, may be subject to access or control restrictions. Thus, operation 308 can include applying a security policy to identify one or more of the deep links as having restricted access controls.

The search engine 102 can provide the functionality illustrated in operation 308 by, for example, applying one or more security trimmers to the results 126. In some embodiments, deep links 124 subject to access restrictions may be removed from, or not added to, the results 126. In other embodiments, deep links 124 subject to security controls can be presented to users with login or other authentication functionality. Examples of applying and/or indicating security controls are illustrated below with reference to FIGS. 4E-4F.

From operation 308, the method 300 proceeds to operation 310, wherein the search engine 102 applies scores associated with the deep links 124, if available. As noted above, the scores can include absolute or relevant values associated with one or more of the deep links 124. As such, the deep links 124 can be ranked according to the scores associated with the deep links 124. In some embodiments, the scores are used as cutoff values that, unless met or exceeded, result in hiding or removal of the deep links 124 from the results 126. Thus, the scores can be used to show/hide the deep links 124 and/or to rank or order the deep links 124.

From operation 310, the method 300 proceeds to operation 312, wherein the search engine 102 presents the results 126. The results 126 include the ordered, ranked, and security-policy-approved deep links 124. The results 126 can be returned to a device or entity that submitted the query 120 or can be provided to another device or entity, if desired. The results 126 can be generated as a result page that is transmitted to the device or entity that submitted the query 120 for rendering at the device, if desired. Some illustrative result pages are illustrated and described below with reference to FIGS. 4A-4F. From operation 312, the method 300 proceeds to operation 314. The method 300 ends at operation 314.

Turning now to FIG. 4A, a UI diagram showing aspects of a UI for presenting deep links 124 in some embodiments will be described. In particular, FIG. 4A shows a screen display 400A generated by the search engine 102 configured to provide the functionality here for presenting the deep links 124. In various implementations, the screen display 400A corresponds to a results page generated by the search application 108, though this is not necessarily the case. The results page can be rendered at a device used to view the results page. For example, in some embodiments the results page is rendered by a web browser or other application executed by a client device 122. It should be appreciated that the UI diagram illustrated in FIG. 4A is illustrative of one contemplated embodiment, and therefore should not be construed as being limited in any way.

The screen display 400A shown in FIG. 4A includes various tool bar and menu items 402. It should be understood that the illustrated tool bar and menu items 402 are illustrative and that additional and/or alternative tool bar and/or menu items are possible and are contemplated. Similarly, various icons, command ribbons, input boxes, and/or other UI controls for viewing and/or interacting with the result page can be presented on the screen display 400A. The screen display 400A includes a search query input box 404 for inputting a search string. The search string entered into the search query input box 404 can be passed to the search engine 102 as the query 120, as is generally understood.

As mentioned above, the screen display 400A is configured to present a result list 406. The result list 406 includes a list of results 408A-D (hereinafter collectively and/or generically referred to as “results 408”) that satisfy a query 120. It can be appreciated that the results 408 presented in the result list 406 can correspond to the results 126 described above with reference to FIG. 1. Also, as explained above, the results 126 can include one or more deep links 124. In some embodiments, the deep links 124 are presented on the result list 406 with the results 408. In the illustrated embodiments, the deep links 124 associated with the results 408 are not shown with the results 408, but can be shown in a window or area of the display by selecting one of the UI controls 410A-C. Selection of the UI controls 410 can cause the search engine 102 or device viewing the result list 406 to display one or more deep links 124, as is described and illustrated in FIG. 4B. It should be understood that this embodiment is illustrative, and should not be construed as being limiting in any way.

According to some embodiments, the UI controls 410A-C can be selected by hovering a mouse pointer 412 or other input device over one of the UI controls 410A-C; by clicking at or near one of the UI controls 410A-C with a mouse or other input device; by touching the display or screen with one or more fingers 426, styluses, and/or other structures or devices at or near the displayed UI controls 410A-C; by submitting a voice command; by submitting commands via one or more key strokes or other input; combinations thereof; and the like. Because the concepts and technologies disclosed herein can be used with various devices that support a number of input devices and/or controls, the above list of commands is to be viewed as illustrative, and not limiting in any way the types of input and/or devices that can be used to view and/or access the deep links 124.

Turning now to FIG. 4B, a UI diagram showing aspects of a UI for presenting deep links 124 in another embodiment will be described. The UI illustrated in FIG. 4B can be, but is not necessarily, generated by the search engine 102 in response to receiving selection of the UI control 410A in FIG. 4A. In other embodiments, the embodiment illustrated in FIG. 4B corresponds to a default view provided by the search engine 102 with the results 126. FIG. 4B shows a screen display 400B generated by the search engine 102 to present the deep links 124. It should be appreciated that the UI diagram illustrated in FIG. 4B is illustrative of one contemplated embodiment, and therefore should not be construed as being limited in any way.

The screen display 400B includes a deep links window 420. The deep links window 420 is illustrated as displaying deep link UI controls 422A-G (hereinafter collectively or generically referred to as “deep links 422”). In the illustrated embodiment, the deep links 422 correspond to hyperlinks for accessing resources associated with the deep links 422. Selection of the deep links 422 can cause the search engine 102 to provide access to the resource associated with the selected deep links 422. In some embodiments, the deep links 422 are displayed in an area of the screen display 400B instead of within the deep links window 420 and/or can be displayed in-line with the results 408. As such, it should be understood that this embodiment is illustrative, and should not be construed as being limiting in any way.

The deep links window 420 also displays a UI control 424 for displaying more deep links. Selection of the UI control 424 can cause the search engine 102 or device displaying the results page to modify the screen display 400B to display additional or alternative deep links 124. FIG. 4C illustrates selection of the UI control 424 by way of a touch gesture entered with a finger 426 or other structure or device. Because the UI control 424 can be selected by any type of input supported by the device used to display the screen displays 400B, 400C, it should be understood that the embodiment illustrated in FIG. 4C is illustrative, and should not be construed as being limited in any way. Although not shown in FIG. 4C, selection of the UI control 424 can expand the deep links window 420 to display more deep links 422 and/or can substitute other deep links 422 for some or all of the deep links 422 displayed in the illustrated deep links window 420.

Turning now to FIG. 4D, a UI diagram showing aspects of a UI for viewing deep links 124 in another embodiment will be described. The UI illustrated in FIG. 4D can be, but is not necessarily, generated by the search engine 102 in response to receiving selection of the UI control 410A in FIG. 4A. In other embodiments, the embodiment illustrated in FIG. 4D is a default view provided by the search engine 102 with the results 126. FIG. 4D shows a screen display 400D generated by the search engine 102 to present the deep links 124. It should be appreciated that the UI diagram illustrated in FIG. 4D is illustrative of one contemplated embodiment, and therefore should not be construed as being limited in any way.

The screen display 400D includes the deep links window 420 and displays the deep links 422 described above with reference to FIG. 4B. In the embodiment illustrated in FIG. 4D, the deep links window 420 also includes security indicators 430. The security indicators 430 can be used to indicate that some, all, or none of the deep links 422 shown in the deep links window 420 are subject to security controls, as explained in detail with reference to operation 308 of the method 300. While the security indicators 430 are shown as icons and the corresponding deep links 422 are shown with italicized type, it should be understood that any type of indicator or indication can be used including, but not limited to, text, font color variations, font styles, and/or other indicators or indications.

In some embodiments, the security indicators 430 are generated in response to applying security trimmers or other security mechanisms to search results identified by the search engine 102. In some implementations, a user can select a security indicator 430 to launch an authentication window 440, as shown in FIG. 4E. As shown in FIG. 4E, the text displayed with deep links 422 subject to security restrictions can be removed and/or substituted with generic identifiers such as “restricted access” or other identifiers.

In some embodiments, such as the embodiment shown in FIG. 4F, the search engine 102 can apply security trimmers to the results 126 to remove or hide deep links 422 that are subject to security restrictions instead of, or in addition to, displaying the indicators 430 shown in FIGS. 4D-4E. As such, the embodiment shown in FIG. 4F is illustrated as including the deep links window 420, but the deep links 422 subject to security controls have been trimmed, removed, hidden, or otherwise withheld from presentation on the screen display 400E. It should be understood that this embodiment is illustrative, and should not be construed as being limiting in any way.

As explained above, some embodiments of the concepts and technologies disclosed herein can be used to display varying numbers of deep links 124 for search results shown on a result page. The number of deep links 124 to display with the search results can be determined based, at least partially, upon scores or other considerations. An example of a screen display 400G showing varied numbers of deep links 422 is shown in FIG. 4G. The screen display 400G also shows the deep links 422 in-line instead of in a deep links window 420. It should be understood that this embodiment is illustrative, and should not be construed as being limiting in any way.

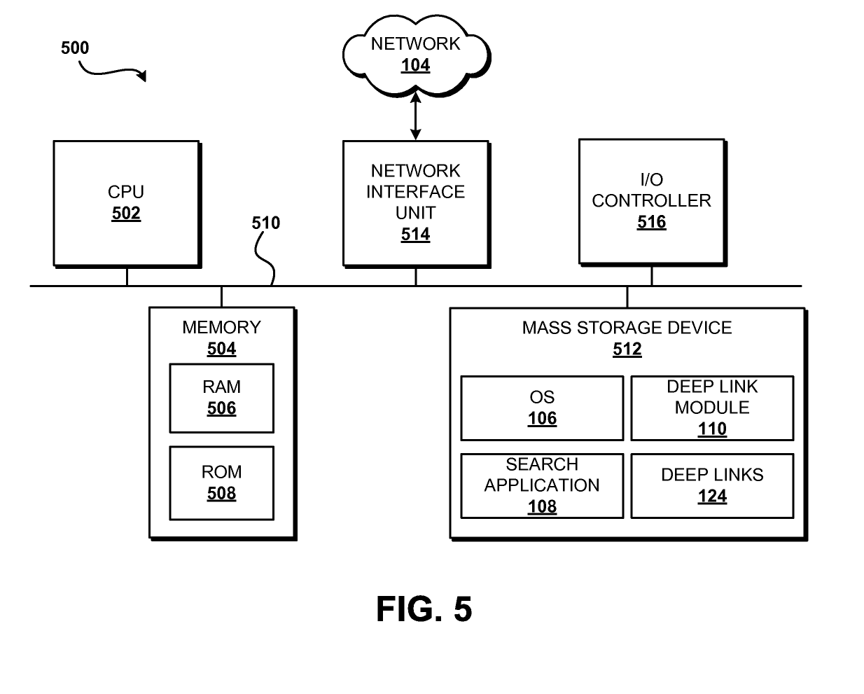

FIG. 5 illustrates an illustrative computer architecture 500 for a device capable of executing the software components described herein for generating and presenting deep links 124. Thus, the computer architecture 500 illustrated in FIG. 5 illustrates an architecture for a server computer, mobile phone, a PDA, a smart phone, a desktop computer, a netbook computer, a tablet computer, and/or a laptop computer. The computer architecture 500 may be utilized to execute any aspects of the software components presented herein.

The computer architecture 500 illustrated in FIG. 5 includes a central processing unit 502 (“CPU”), a system memory 504, including a random access memory 506 (“RAM”) and a read-only memory (“ROM”) 508, and a system bus 510 that couples the memory 504 to the CPU 502. A basic input/output system containing the basic routines that help to transfer information between elements within the computer architecture 500, such as during startup, is stored in the ROM 508. The computer architecture 500 further includes a mass storage device 512 for storing the operating system 106, the search application 108, the deep link module 110, and/or other application programs. The mass storage device 512 also can be configured to store the deep links 124 and other data, if desired.

The mass storage device 512 is connected to the CPU 502 through a mass storage controller (not shown) connected to the bus 510. The mass storage device 512 and its associated computer-readable media provide non-volatile storage for the computer architecture 500. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 500.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 500. For purposes the claims, the phrase “computer storage medium” and variations thereof, does not include waves, signals, and/or other transitory and/or intangible communication media, per se.

According to various embodiments, the computer architecture 500 may operate in a networked environment using logical connections to remote computers through a network such as the network 104. The computer architecture 500 may connect to the network 104 through a network interface unit 516 connected to the bus 510. It should be appreciated that the network interface unit 516 also may be utilized to connect to other types of networks and remote computer systems, for example, the web servers 116, the client device 122, and/or other systems or devices. The computer architecture 500 also may include an input/output controller 518 for receiving and processing input from a number of other devices, including a keyboard, mouse, or electronic stylus (not shown in FIG. 5). Similarly, the input/output controller 518 may provide output to a display screen, a printer, or other type of output device (also not shown in FIG. 5).

It should be appreciated that the software components described herein may, when loaded into the CPU 502 and executed, transform the CPU 502 and the overall computer architecture 500 from a general-purpose computing system into a special-purpose computing system customized to facilitate the functionality presented herein. The CPU 502 may be constructed from any number of transistors or other discrete circuit elements, which may individually or collectively assume any number of states. More specifically, the CPU 502 may operate as a finite-state machine, in response to executable instructions contained within the software modules disclosed herein. These computer-executable instructions may transform the CPU 502 by specifying how the CPU 502 transitions between states, thereby transforming the transistors or other discrete hardware elements constituting the CPU 502.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 500 in order to store and execute the software components presented herein. It also should be appreciated that the computer architecture 500 may include other types of computing devices, including hand-held computers, embedded computer systems, personal digital assistants, and other types of computing devices known to those skilled in the art. It is also contemplated that the computer architecture 500 may not include all of the components shown in FIG. 5, may include other components that are not explicitly shown in FIG. 5, or may utilize an architecture completely different than that shown in FIG. 5.

Based on the foregoing, it should be appreciated that technologies for generating and presenting deep links have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

We claim:

1. A computer-implemented method for generating deep links, the computer-implemented method comprising performing computer-implemented operations for:
analyzing a site and data relating to the site to identify resources associated with the site;
generating one or more deep links identifying the resources associated with the site;
associating the one or more deep links with the site; and
storing data identifying the deep links in a search index.

2. The method of claim 1, wherein the site is identified during an index operation executed by a search engine.

3. The method of claim 1, wherein the resources comprises a link appearing in the site.

4. The method of claim 3, further comprising calculating a score for each of the one or more deep links, the score being based, at least partially, upon a usage metric associated with the link.

5. The method of claim 4, further comprising storing data indicating the score with the deep links, wherein the score comprises a user-defined importance associated with at least one of the deep links.

6. The method of claim 1, wherein the search index stores data identifying the site, and wherein the deep links are stored in the search index as properties of the data identifying the site.

7. The method of claim 1, further comprising:
obtaining search results satisfying a query, the search results comprising data identifying the site;
identifying one or more deep links associated with the site; and
returning the deep links with the search results.

8. The method of claim 7, wherein returning the deep links with the search results comprises generating a user interface comprising the search results and the deep links.

9. The method of claim 7, further comprising:
applying a security mechanism to the deep links to filter the deep links; and
analyzing a score associated with a deep link to rank the deep links.

10. A computer storage medium having computer readable instructions stored thereupon that, when executed by a computer, cause the computer to:
execute an indexing operation at a search engine to identify a site;
analyze the site and data relating to the site to identify resources associated with the site;
generate one or more deep links identifying the resources associated with the site;
associate the one or more deep links with the site; and
store data identifying the site, the deep links, and an association of the site with the deep links in a search index.

11. The computer storage medium of claim 10, further comprising computer-executable instructions that, when executed by the computer, cause the computer to:
calculate a score for each of the one or more deep links; and
store data indicating the score in the search index.

12. The computer storage medium of claim 11, wherein the score is based, at least partially, upon at least one of a click-through rate associated with the resource or a read-through rate associated with the resource.

13. The computer storage medium of claim 11, wherein the score is based, at least partially, upon a number of clicks required to navigate to the resource from the site.

14. The computer storage medium of claim 10, wherein the deep links are stored in the search index as properties of the data identifying the site.

15. The computer storage medium of claim 10, further comprising computer-executable instructions that, when executed by the computer, cause the computer to:
execute a search query against the search index;
obtain search results satisfying the search query, the search results comprising data identifying the site;
identify one or more deep links associated with the site; and
return results to an entity that submitted the search query, the results comprising data identifying the deep links and data identifying the search results.

16. The computer storage medium of claim 15, wherein returning the results comprises generating a result page with information identifying the site and the one or more deep links associated with the site.

17. The computer storage medium of claim 16, further comprising computer-executable instructions that, when executed by the computer, cause the computer to:
apply a security mechanism to the deep links to filter the deep links;
analyze a score associated with a deep link to rank the deep links; and
modify the results based upon at least one of the security mechanisms or the score.

18. A computer storage medium having computer readable instructions stored thereupon that, when executed by a computer, cause the computer to:
execute an indexing operation at a search engine to identify a site hosted by a web server;
analyze the site and data relating to the site to identify resources associated with the site, the data comprising search information and usage information associated with the resources;
generate one or more deep links comprising data identifying the resources associated with the site;
associate the one or more deep links with the site; and
store data identifying the site, the one or more deep links, and an association of the site with the deep links in a search index, wherein the data identifying the one or more deep links is stored as a property of the data identifying the site.

19. The computer storage medium of claim 18, further comprising computer-executable instructions that, when executed by the computer, cause the computer to:
calculate a score for each of the one or more deep links; and
store data indicating the score in the search index, wherein the score is based, at least partially, upon the search information and the usage information associated with the resources.

20. The computer storage medium of claim 19, further comprising computer-executable instructions that, when executed by the computer, cause the computer to:
execute a search query against the search index;
obtain search results satisfying the search query, the search results comprising data identifying the site;
identify one or more deep links associated with the site;
generate a result page with information identifying the site and the one or more deep links associated with the site; and
return the result page to an entity that submitted the search query.
